(19) United States
(12) Patent Application Publication
(10) Pub. No.: US 2005/0066701 A1
(43) Pub. Date: Mar. 31, 2005

(54) Method for making a metal sheet having a decorative pattern

(76) Inventors: James W. Halliday JR., Gibsonia, PA (US); Frederic J. Deuschle, Wexford, PA (US)

Correspondence Address: PAUL A. BECK & ASSOCIATES;SUITE 100, 1575 McFARLAND ROAD, PITTSBURGH, PA, 15216-1808, US

(21) Appl. No.: 10/672,028

(22) Filed: Sep. 26, 2003

(51) Int. Cl. B23P 25/00; B21D 33/00

(52) U.S. Cl. 72/252.5; 29/17.2

(57) ABSTRACT

A method to make a decorative pattern on a surface of a metal sheet. The metal sheet is fed to a work roll which has an orbital abrasive pattern on the work roll. The work roll is applied under pressure to the surface of the metal sheet and leaves an impression of the decorative pattern in the form of the orbital abrasive pattern on the surface of the metal sheet.

### BACKGROUND OF THE INVENTION

1. Field of the Invention

The invention relates to a method for making a decorative pattern on a surface of the metal sheet. The method uses a work roll which has an orbital abrasive pattern on the roll. The roll applies pressure to the metal sheet or strip in contact with the roll which impresses the decorative pattern on the surface of the metal sheet.

2. The Problem Presented and Prior Methods

There is a market for metal sheet which has a decorative surface texture. This sheet is desired by builders and architects who use the sheet in various structures. Examples of uses are railings and wall panels used in buildings both inside and outside. The metal sheet can be stainless steel, titanium or other metal.

The current decorative surface texture produced on the metal sheet is shown in FIG. 1. It is referred to in the marketplace by a number of terms namely: angel hair; orbitally sanded finish; or vibration finished material. All of these will be referred to as an orbital abrasive which is considered a decorative pattern. This gives a multi-directional finish. This means that when viewed from any direction about 360°, the orbital abrasive pattern appears to the eye to be the same. This is desired over a pattern which changes as the eye views the pattern on the metal surface from different directions. The multi-directional effect is desired in the marketplace for the orbital abrasive pattern on the metal sheet surface.

The current method of making an orbital abrasive pattern involves the use of orbital sanders traversing metal sheets one at a time. Better versions are produced with numerically controlled heads on an overhead rigging and mounted above a table upon which the metal work piece such as a sheet rests. This existing method is costly. It takes one hour to decorate a sheet with an orbital abrasive pattern. Manufacturers are looking for a better way to create this pattern on the metal sheet and have not found it. The conventional sanding process described above has the following deficiencies:

(i) Low productivity and high cost to manufacture;

(ii) Inherent surface variability due to the wearing out of abrasive media. In the case of hand-applied vibration texture, there is the added variability that comes from operator body position relative to the work piece and operator fatigue;

(iii) Potential distortion of metal flatness caused by heat generation on one side of the sheet. This is more of a factor on lighter gauge sheet;

(iv) Limited to cut length sheets; and

(v) In the case of titanium, there is potentially explosive titanium dust created in the process.

### BRIEF SUMMARY OF THE INVENTION

The invention is a method for making a metal sheet having a decorative pattern on a surface of the sheet. An orbital abrasive pattern which is considered to be a decorative pattern is applied to a metal work roll. The metal work roll with the decorative pattern is applied under pressure to the metal sheet to imprint the decorative pattern to the metal sheet.

The orbital abrasive pattern applied to the work roll is a multi-directional grit line pattern that is usually comparable to a sheet that has been processed with orbitally-controlled abrasive equipment. The work roll can be used as part of a pair of work rolls that are aligned and together press against the metal sheet. The metal sheet can be in the form of a coil of strip which is continuously fed from the strip coil through pair of work rolls which impress the decorative pattern and thus recoiled to form a roll of metal having a decorative surface. We propose to impart the same texture by rolling the metal (in coil form) on a temper mill fitted with work rolls that have been surface conditioned with the appropriate pattern.

We apply the work roll under pressure that is an amount that does not cause the metal sheet to exceed three and one half percent reduction in the thickness of the metal sheet so as to limit a visual manifestation of rolling direction. If desired, we apply the work roll to the metal sheet up to four times to create a decorative pattern density which is greater than when the metal sheet has the work roll applied to the metal sheet once.

The orbital abrasive pattern applied to the work roll has an average surface depth that does not exceed sixty microinches. The orbital abrasive pattern on the surface of the metal sheet does not exceed forty microinches in depth. A second work roll in alignment with the work roll to which the orbital abrasive pattern has been applied work together to exert pressure onto the metal sheet.

Sometimes the orbital abrasive pattern is applied to the second roll as well as the other roll. This is done in the event one side of the metal sheet is able to produce a side with the decorative pattern which is better than the other side.

The resulting product will be less costly to produce, more uniform in appearance than conventionally produced product and will not bear the risk of shape distortion of the metal which can occur during processing in the conventional way. In the case of titanium, there is an added measure of safety that is achieved with the temper rolling method in that no potentially explosive titanium dust is created in the process.

### BRIEF DESCRIPTION OF THE DRAWINGS

FIG. 1 is an SEM image of an orbital abrasive pattern.

FIG. 2 is a diagrammatic drawing of the process showing work rolls.

### DETAILED DESCRIPTION OF A PREFERRED EMBODIMENT

Below is a list of definitions which helps to explain by example or discussion what the defined terms may include to assist in understanding the terms.

### Definitions

Metal Sheet—can include steel, titanium or other metals. It can be in the form of a single sheet or a strip which is in a coil and can be uncoiled and recoiled.

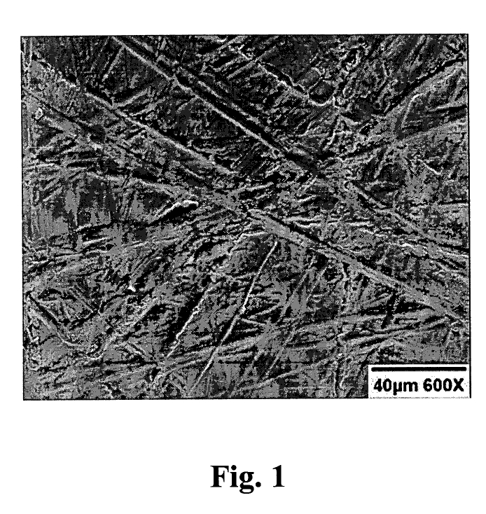

Decorative pattern—includes a decorative surface texture on a metal sheet or strip. It is referred to in the marketplace as: angel hair; an orbitally sanded finish; or a vibration finished material. All of these can be referred to as an orbital abrasive pattern. It can be referred to as a vibration texture which is a non-directional texture. This means that when the texture is viewed about 360° from different angles the surface has similar characteristics. A vibration texture can be created using a rotating abrasive disc that swirls across the surface of the metal then repeats itself with a variation of position. Other methods to create the finish texture can include a spinning polish disc with an offset cam to break symmetry. Another way can pass sheet metal or strip below reciprocating abrasive pad. An example of such a pattern is shown in FIG. 1.

Orbital abrasive pattern—includes the decorative pattern described above.

Metal work roll—includes a work roll that can be found in a temper mill.

Multi-directional grit line pattern—includes that described in the decorative pattern and produced with orbitally-controlled abrasive equipment.

Orbitally controlled abrasive equipment—includes a rotating abrasive disc that swirls across a surface.

Mandrel—spindle or drum that rotates about an axis used to unwind and rewind (or uncoil and recoil) a coiled metal sheet.

### Description

FIG. 1 shows an SEM Image of a decorative pattern on a surface of a metal sheet.

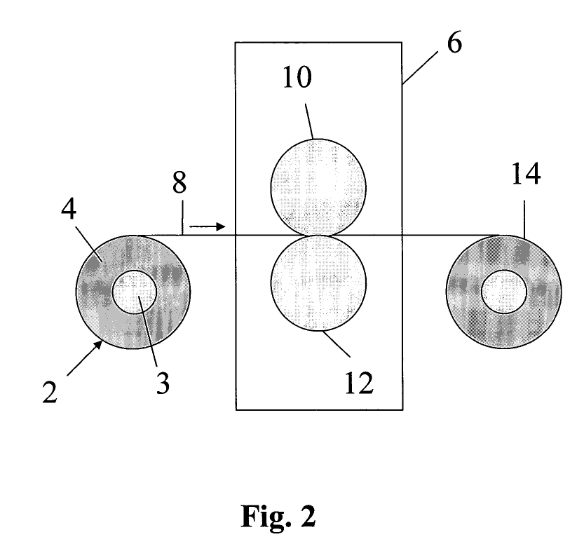

FIG. 2 shows a diagrammatic flow chart of the process for creating the decorative pattern on a surface of the metal sheet surface.

A metal coil 2 of metal strip 4 is loaded onto a mandrel 3. This allows the metal strip 4 to be uncoiled and fed to a temper mill 6. The metal strip 4 is uncoiled from the metal coil 2. The metal strip 4 has a surface 8 which is fed to work rolls 10 and 12. The work rolls 10 and 12 are turned in opposite directions from each other. Work roll 10 has the decorative pattern of the type shown in FIG. 1 on its surface. As the metal strip 4 is moved between the work rolls 10 and 12. The decorative pattern is applied from work roll 10 under pressure to the surface 8 of the metal strip 4. The pressure is sufficient to create the desired decorative pattern of the type shown in FIG. 1. After the metal strip 4 passes from the work rolls 10 and 12 it is recoiled into a metal coil 14 and is available for further processing.

The method is capable of processing a variety of metals, including stainless steel, titanium, zinc, copper and aluminum. Metals processed in this manner are suitable for architectural, appliance and other applications requiring a decorative metal sheet.

The work roll 10 has the decorative pattern applied by orbital abrasive techniques. This can be done by hand or by machine by using a rotating abrasive disc to impress the decorative pattern into the work roll. It should be understood that either work roll 10 or 12 or both can have the decorative pattern applied.

Various changes could be made in the above construction and method without departing from the scope of the invention as defined in the claims below. It is intended that all matter contained in the above description as show in the accompanying drawings shall be interpreted as illustrative and not as a limitation.

1. A method for making a metal sheet having a decorative pattern on a surface of the sheet comprising:
(a) providing a metal sheet;
(b) applying an orbital abrasive pattern that is considered a decorative pattern to a metal work roll; and
(c) applying the work roll having the decorative pattern under pressure to the metal sheet to imprint the decorative pattern to the metal sheet.

2. A method for making a metal sheet having a decorative pattern on a surface of the sheet as recited in claim 1 wherein the orbital abrasive pattern applied to the work roll is a multi-directional grit-line pattern that is visually comparable to a sheet that has been processed with orbitally controlled abrasive equipment.

3. A method for making a metal sheet having a decorative pattern on a surface of the sheet as recited in claim 2 wherein the metal sheet provided is in the form of a coil of strip which is advanced to the work roll.

4. A method for making a metal sheet having a decorative pattern on a surface of the sheet as recited in claim 2 where applying the work roll under pressure is in an amount that does not cause the metal sheet to exceed three and one half percent reduction in the thickness of the metal sheet so as to limit a visual manifestation of rolling direction.

5. A method for making a metal sheet having a decorative pattern on a surface of the sheet as recited in claim 2 including applying the work roll to the metal sheet up to four times so as to create a decorative pattern density which is greater than when the metal sheet has the work roll applied to the metal sheet once.

6. A method for making a metal sheet having a decorative pattern on a surface of the sheet as recited in claim 2 wherein the orbital abrasive pattern applied to the work roll has an average surface depth that does not exceed sixty microinches.

7. A method for making a metal sheet having a decorative pattern on a surface of the sheet as recited in claim 2 wherein the resulting orbital abrasive pattern on the surface of the metal sheet does not exceed forty microinches in depth.

8. A method for making a metal sheet having a decorative pattern on a surface of the sheet as recited in claim 2 including a second work roll in alignment with the work roll to which the orbital abrasive pattern has been applied and together both work rolls exert pressure onto the metal sheet.

9. A method for making a metal sheet having a decorative pattern on a surface of the sheet as recited in claim 8 wherein the second work roll has the orbital abrasive pattern applied.
